(19) United States
(12) Patent Application Publication
(10) Pub. No.: US 2019/0078369 A1
(43) Pub. Date: Mar. 14, 2019

(54) SAFETY GATE APPARATUS

(71) Applicant: Diverse Holdings, LLC, Delaware, OH (US)

(72) Inventors: Carl L. Stover, Ostrander, OH (US); Craig T. Jones, Johnstown, OH (US); Dennis R. Weber, Delaware, OH (US)

(21) Appl. No.: 15/702,073

(22) Filed: Sep. 12, 2017

(51) Int. Cl. E05F 13/02; E06B 9/04; E05F 1/10; E06B 11/02; E05B 65/00; E05F 17/00

(52) U.S. Cl. CPC E05F 13/02; E06B 9/04; E05F 1/10; E06B 2009/002; E05B 65/0007; E05F 17/00; E06B 11/022

(57) ABSTRACT

The present application provides a safety gate apparatus which is configured to receive the delivery of goods by way of fork lift therethrough while simultaneously preventing falls and injury. A version of the safety gate apparatus comprises a first and second support structures which are laterally disposed defining a delivery space therebetween for ingress and egress of the forks of the fork lift, and a moveable gate assembly supported by the first and second support structures moveable between a closed, default position and an open position.

### BACKGROUND

The present invention relates to the field of safety gates.

In industrial applications, mezzanine floor systems are semi-permanent floor systems typically installed within buildings, built between two permanent original stories. These structures are usually free standing and, in most cases, can be dismantled and relocated. Commercially sold mezzanine structures are generally constructed of steel, aluminum, and fiberglass.

Mezzanines are frequently used in industrial operations such as warehousing, distribution or manufacturing. These facilities have high ceilings, allowing unused space to be utilized within the vertical cube. Industrial mezzanine structures are typically either structural, roll formed, rack-supported, or shelf-supported, allowing high density storage within the mezzanine structure.

Mezzanines are often built without fall protection resulting in frequent accidents including serious injury and even death. Moreover, in order for fork lifts and other machinery to access and deliver and receive goods to and from a mezzanine level, an opening must be present within existing railing and barrier systems. There have been many attempts to try and solve this problem without any reliable, cost effective solution. For example, employees have been required to connect themselves by a cord or other connection means to part of the mezzanine structure, such that if they did fall the cord would prevent them from falling over the side of the mezzanine onto the floor below. However, this requires that the employee painstakingly follow through with connecting and disconnecting throughout each position on the mezzanine. This process of connecting and disconnecting requires substantial time and effort in order to properly follow through. Other varying gate and rail solutions have been tried without success such as duel interlock roll around gates, barn door style gates, or gates that swing open. However, these types of design are expensive and require more space, thus reducing the available storage. Moreover, electric hand rail systems have been tried, but have been found to be extremely costly and require an operator.

For the foregoing reason, there is a need for an apparatus that will provide a cost efficient, yet safe and reliable, easy to remove and operate fall protection for mezzanines and other platform applications.

### SUMMARY

In accordance with the invention, a safety gate apparatus is provided which couples as a cost efficient and reliable gate for preventing falls and injury as well as a gate that can easily be adapted for use in conjunction with a fork lift for delivery of goods to and from an elevated platform. This provides a safe, low-cost, and time saving approach for preventing falls while efficiently delivering goods to and from an elevated platform without hassle.

The invention generally comprises a support structure for supporting a gate assembly that is configured to move between a default, closed position to an open position. Ideally, the gate is opened, providing a delivery space for delivery of goods to a platform, by the application of force by way of the forks of a forklift. After the presence of the forks are removed from the gate, the safety gate will automatically return to the default, close position which provides a lower barrier and an upper barrier that is qualified to meet or exceed OSHA law and regulations per the United States Department of Labor, thereby preventing fall and mitigating risk.

In a version of the invention, a safety gate apparatus is provided which comprises (a) a first and second support structures, each having a base portion and an upper portion, wherein the support structures are laterally disposed defining a delivery space therebetween for ingress and egress of the forks of the fork lift; (b) a moveable gate assembly supported by the first and second support structures and moveable between the closed, default position and the open position, the gate assembly comprising: (i) a base plate having a substantially flat surface, a forward perimeter and aft perimeter, the base plate pivotally connected to the base portion of each of the first and second support structures near the front perimeter about a first axis of rotation and is configured to operably move through a path of motion between the default, closed position and the open position, wherein while in the default, closed position, the base plate flat surface extends vertically parallel with and between the first and second support structures forming a lower barrier, and wherein while the base plate is in the open position, the base plate is perpendicular and substantially aft of the first and second support structures; (ii) first and second gate arms each having a proximal and distal end, each gate arm pivotally and operably connected to the upper portion of the respective first and second support structures and each is configured to pivotally move about a first axis of rotation and a second axis of rotation respectively through a path of motion between the default, closed position and the open position, wherein while in the closed, default position, each gate arm longitudinally aligns with the other to form an upper barrier between the upper portions of each of the support structures, and wherein while in the open position, each gate arm pivots aft of their respective support structures defining an unhindered length of space between the upper portions of each support structure; and wherein each gate arm is mechanically linked to the movement of the base plate, wherein as the base plate moves aft through its path of motion, each of the gate arms simultaneously move aft through their respective paths of motion.

In a version of the application, the safety gate apparatus further comprises a locking means for selectively locking the gate assembly in a static position, whereby a user can selectively lock the gate assembly in the default, open position or the closed position during operation thereof.

In a detailed version of the application, each gate arm is operably connected to the plate via a mechanical linkage embedded within each respective support structure, wherein each mechanical linkage comprises: a linear shaft having a top end, a bottom end, and an axis of rotation, the linear shaft extending between the bottom portion and the upper portion within the respective vertical support structure; the top end of the shaft operably connected to the rotational movement of the respective gate arm; a first gear operably positioned at the bottom end of the linear shaft; and a second gear operably connected to the rotational movement of the base plate, wherein the second gear is operably configured to engage the first gear throughout the path of motion of the base plate.

In yet another detailed version, the safety gate base plate has a rectangular perimeter defining a flat linear surface having opposing side perimeters, and opposing side rails positioned at each side perimeter extending normal to the linear surface forming a tray configuration.

Still other versions, benefits and advantages of the invention will become apparent to those skilled in the art to which it pertains upon a reading and understanding of the following detailed specification.

### BREIF DESCRIPTION OF THE DRAWINGS

These and other features, aspects, and advantages of the present invention will become better understood with regard to the following description and accompanying figures where:

FIG. 1 is a front perspective view of a version shown while in an open position;

FIG. 2 is a front perspective view shown while in the default, closed position of the version shown in FIG. 1;

FIG. 3 a rear perspective view while in the default, closed position of the version shown in FIG. 1;

FIG. 4 is a front perspective view while in the default, closed position of the version shown in FIG. 1;

FIG. 5 is an enlarged portion taken from FIG. 4 thereof;

FIG. 6 is an enlarged exploded view taken from FIG. 4 thereof; and

FIG. 7 is an enlarged exploded view taken from FIG. 4 thereof;

FIG. 8 is a front perspective view of a version shown while in an open position; and

FIG. 9 is a front perspective view shown while in the default, closed position of the version shown in FIG. 8;

### DETAILED DESCRIPTION

Referring now to the figures wherein the showings are for purposes of illustrating a preferred version of the invention only and not for purposes of limiting the same, the present invention is safety gate apparatus configured to move between a default, closed position and an open position. The safety gate provides a safe, ergonomic safety barrier for preventing falls and injury as well as a gate that can easily be opened by existing equipment such as a fork lift by the application of minimal force. The safety gate meets or exceeds industry standards in its current form.

The following detailed description is of the best currently contemplated modes of carrying out exemplary versions of the invention. The description is not to be taken in the limiting sense, but is made merely for the purpose illustrating the general principles of the invention, since the scope of the invention is best defined by the appended claims.

Various inventive features are described below that can each be used independently of one another or in combination with other features.

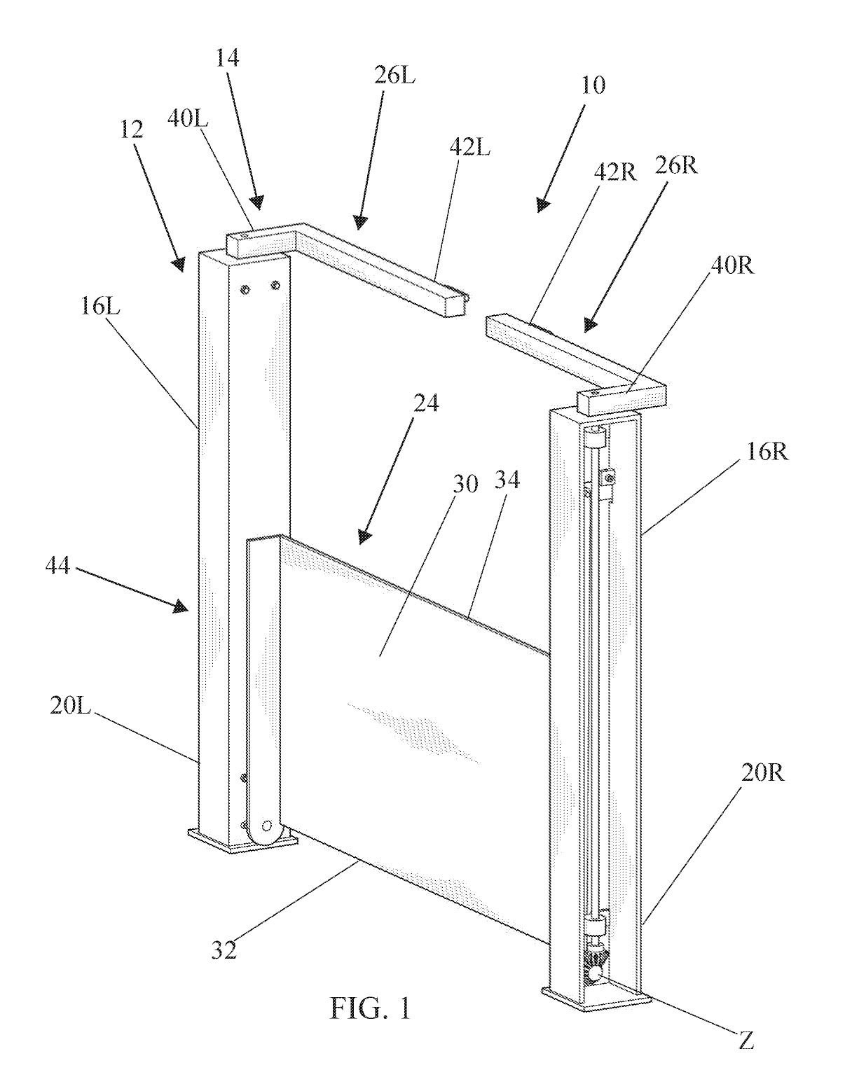

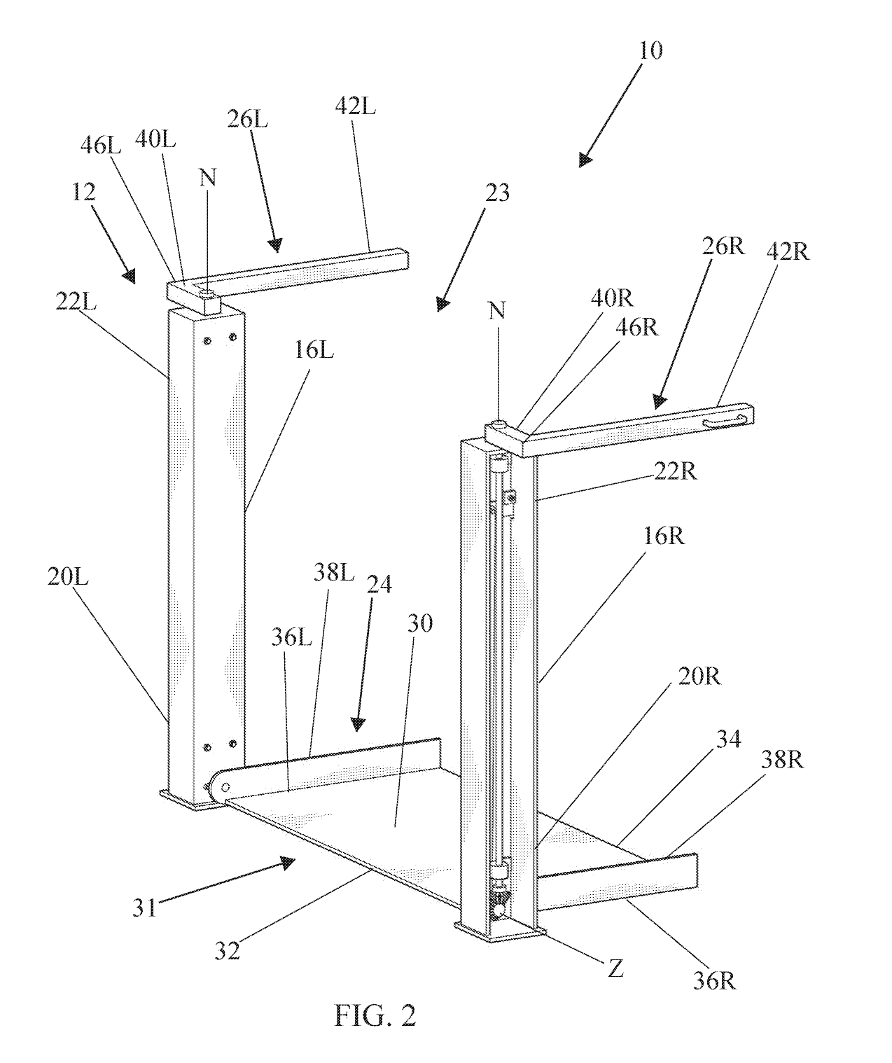

With reference to the figures, particularly FIG. 1 and FIG. 2 generally, a description of a version of the invention will be provided and is generally designated as numeral 10. FIG. 1 is front perspective view of a version of the safety gate 10 while in a default, closed position and FIG. 2 illustrates the safety gate 10 while in the open position. By way of overview, the safety gate 10 generally comprises a support assembly 12 and a gate assembly 14. Generally, the support assembly 12 supports the moveable gate assembly 14 throughout its path of motion from the default, closed position (FIG. 1) to the open position (FIG. 2).

In further detail, the support assembly 12 generally comprises a first and second vertical support structures 16L, 16R which house some of the working components of the gate assembly 14. The support structures 16L, 16R are laterally positioned defining a delivery space 23 therebetween, particularly shown in FIG. 2 while the gate assembly 10 is in the open position. Each support structure 16L, 16R has a base portion 20R, 20L and an upper portion 22L, 22R. The base portion 20L, 20R of each support structure 16L, 16R is fixedly attached to a surface (not shown) such as the floor of a mezzanine structure near the outer exposed perimeter thereof or other raised platform providing a surface. The vertical support structures 16L, 16R extend upward terminating at the upper portion 22R, 22L, thereby defining the overall general height of the safety gate 10. Thus overall, the support structures 16R, 16L provide the basic structure for providing a defined lateral delivery space 23 (See FIG. 2) or opening for access to and from the elevated platform.

As best illustrated by FIG. 1 and FIG. 2, the gate assembly 14 generally encompasses the moving parts of the gate assembly 10. In particular, the gate assembly 14 generally comprises a pivoting base plate 24 mechanically connected to move in unison to a first gate arm 26L and a second gate arm 26R.

In the illustrated version, the base plate 24 comprises a substantially flat linear surface 30 having a forward portion 31 including a forward perimeter 32 and aft perimeter 34 and opposing side perimeters 36L, 36R. The base plate 24 forward portion 31 is pivotally and operably connected between opposing base portions 20L, 20R of the first and second support structures 16L, 16R. The base plate 24 operably pivots about an axis of rotation Z passing between each support structure 16L, 16R base portion 20L, 20R and traversing the base plate 24 as best shown in FIG. 2.

In the detailed version and as best illustrated by FIG. 2, the base plate 24 further comprises opposing side rails 38L, 38R positioned at each side perimeter 36R, 38L respectively, each extending normal to the linear surface 30 forming a tray like configuration. In the version, the base plate 24 axis of rotation Z extends through each side rail 38L, 38R near the forward portion 31 and parallel with the linear surface 30, thereby offsetting the linear surface 30 a distance from and about the rotational axis Z.

The base plate 24 is configured to operably move through a path of motion from a vertical, gate closed position to a horizontal, gate open position. Referring to FIG. 1, while in the gate vertical, closed position, the base plate 24 linear surface 30 generally extends vertically parallel with and between the first and second support structures 16L, 16R. Thereby, forming a lower barrier configuration 44 extending between the first and second support structures 16L, 16R while in the gate closed position. Referring to FIG. 2, while in the gate open position, the base plate 24 linear surface 30 generally extends horizontally parallel with the floor of the raised structure and/or substantially perpendicular and aft of the first and second support structures 16L, 16R.

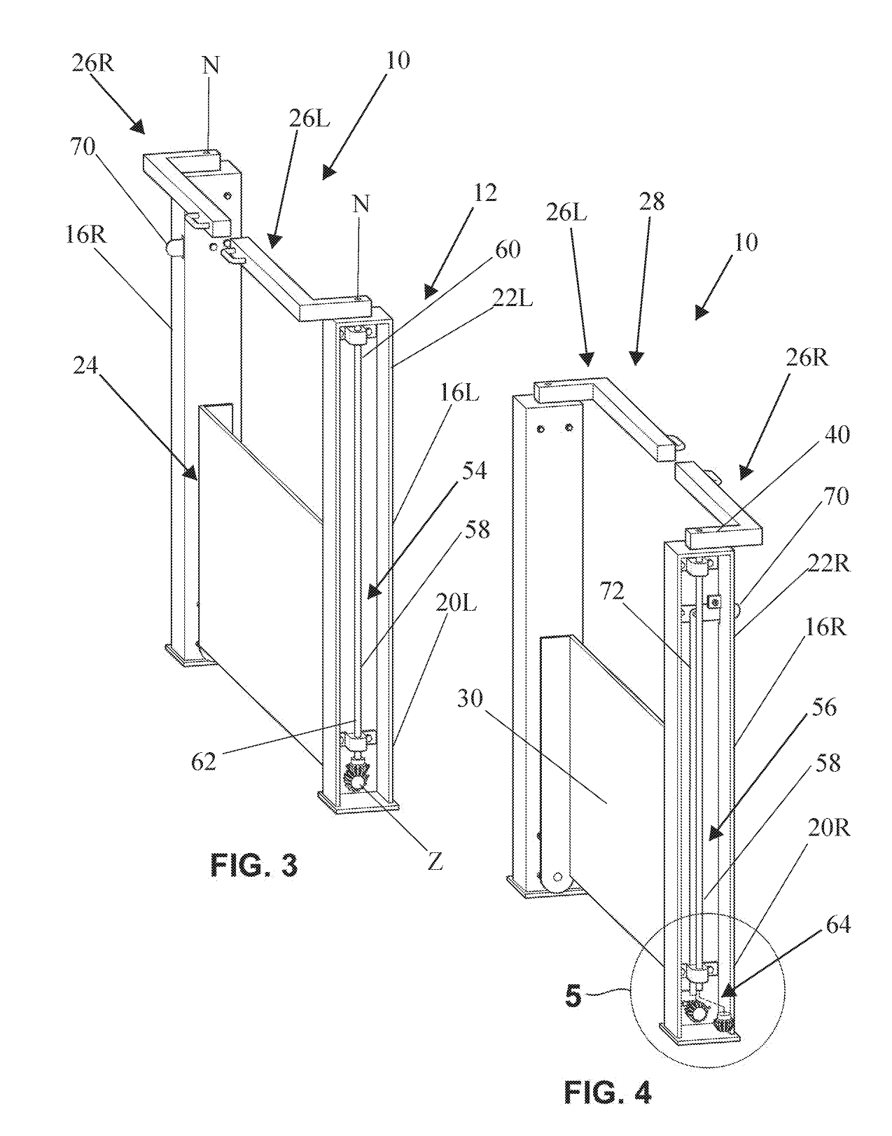

The gate assembly 14 further comprises a first and second upper gate arms 26L, 26R, each pivotally attached to the upper portion 22L, 22R of each respective support structures 16L, 16R. Each gate arm 26L, 26R generally operably pivots horizontally a closed gate position (FIG. 1) and an open gate position (FIG. 2). In more detail, each gate arm 26L, 26R comprises a proximal end 40L, 40R and a distal end 42L, 42R. The proximal end 40L, 40R is pivotally attached to the upper portion 22L, 22R about rotational axis N, with the remaining length terminating at the distal end 42L, 42R which moves through a semi-arc path of motion about the rotational axis N between the closed gate position (FIG. 1) and the open gate position (FIG. 2). Referring to FIG. 1, while each gate arm 26L, 26R is in the closed gate position, the gate arms 26L, 26R longitudinally align to form an upper barrier 28 (See FIG. 3 and FIG. 4) between the upper portions 22L, 22R of the support structures 16L, 16R. Thereby, preventing ingress and egress through the upper area of the safety gate 10, further preventing falls and other objects moving through the safety gate 10 while in the gate closed position. Referring to FIG. 2, while each gate arm 26, 28 is in the open position, extending aft of the gate assembly 14, the gate arms 26, 28 define an unhindered length of space between the upper portions 22L, 22R of the vertical support structures 16L, 16R. Thereby, allowing objects to pass through the safety gate 10, typically introduced by way of fork lift, to and from a raised platform positioned behind the safety gate 10.

As illustrated best in FIG. 2, in a version, each gate arm 26L, 26R includes an elbow 46L, 46R bisecting the proximal member 40L, 40R and a distal member 42L, 42R. Each gate arm 26L, 26R is generally a reciprocal configuration of the other. The proximal member 40L, 40R and the distal member 42L, 42R connected perpendicular with respect to the other. Wherein the proximal members 40L, 40R offsets the distal members 42L, 42R a distance from the rotational axis N and maintains the distal member 42L, 42R aft of the base plate 24 linear surface 30 while in the gate closed position (FIG. 2). Thus, during operation, the load of the fork lift (not shown) will make contact with the base plate 24 linear surface 30 before making contact with the gate arms 26L, 26R while opening the safety gate 10, further described in detail below.

In the version as best illustrated by FIG. 3-FIG. 7, each gate 26L, 26R arm is operably and mechanically connected to move in conjunction with the base plate 24 throughout the gate closed position (FIG. 1) to the gate open position (FIG. 2). The base plate 24 and each gate arm 26L, 26R are operably connected by way of a mechanical linkage assembly. Mechanical linkage assembly generally connects the rotational movement of the gate arms 26L, 26R with the rotational movement of the base plate 24. As illustrated in the example version, the first gate arm 26L axis of rotation N is operably connected to the first side of the base plate 24 axis of rotation by way of mechanical linkage 54 and the second gate arm 26R axis of rotation N is operably connected to the opposing second side of the base plate 24 axis of rotation by way of Z mechanical linkage 56. Wherein, each mechanical linkage 54, 56 is substantially encased within the respective vertical support member 16L, 16R.

In the illustrated version, the mechanical linkage 54, 56 for each side generally comprises a linear shaft 58 having a top end 60 and a bottom end 62 which extends between the base portion 20 and the upper portion 22 of the vertical support structures 16L, 16R. The top end 60 of the linear shaft 58 operably connects with the proximal end 40 of the respective gate arms 26—providing the axis of rotation N thereof. The bottom end 62 of the linear shaft 58 operably connects with the adjacent side of the base plate 24 axis of rotation Z by way of a bevel type gear assembly 64 as illustrated in FIG. 4.

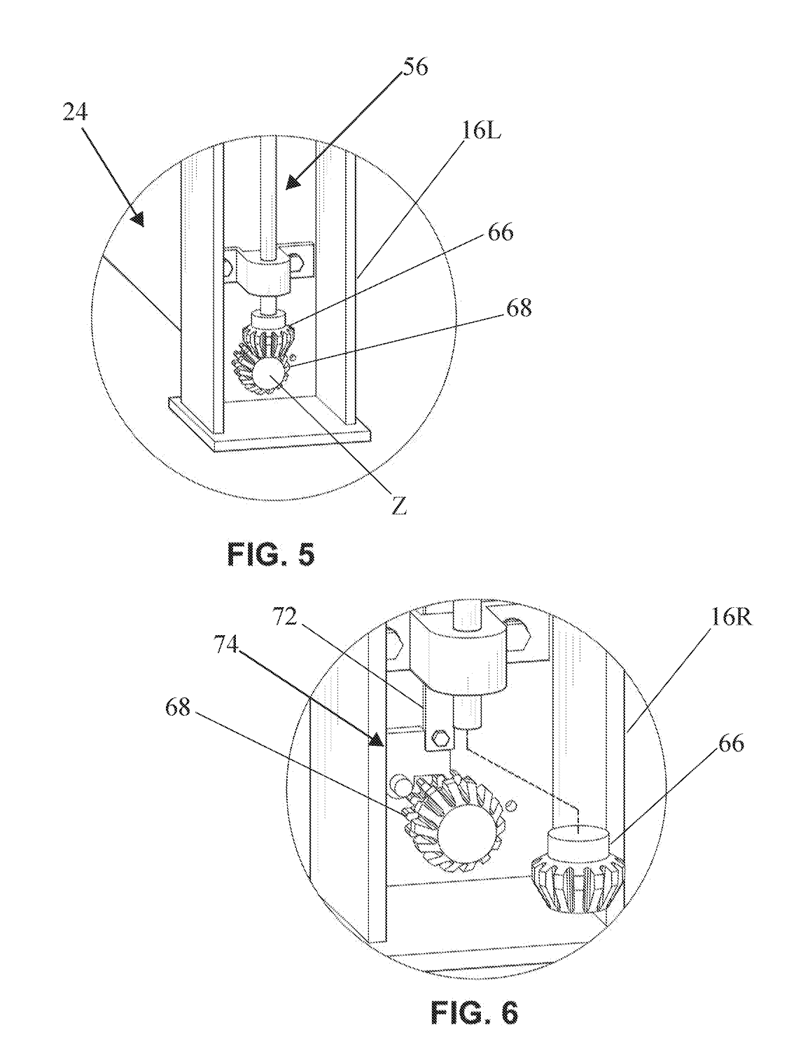

As best illustrated by FIG. 4, an enlarged portion taken from FIG. 5, the bevel type gear assembly 64 includes a first bevel gear 66 operably and axially positioned at the bottom end 62 of the vertical linear shaft 58 and the second bevel gear 68 is operably connected to and axially aligned with the base plate 24 axis of rotation Z, wherein the second bevel gear 68 is operably configured to engage the first bevel gear 66 throughout the rotational movement of the base plate 24. Thereby, as the base plate 24 moves from the vertical closed, gate position to the horizontal open gate position, it simultaneously actuates—via the mechanical linkage assembly—the first and second gate arms 26L, 26R throughout their respective paths of motion.

Referring now to FIG. 4-FIG. 7, a version of the application may include a means for locking the position of the safety gate 10. The means for locking ensures that the safety gate 10 will remain in the gate open position if needed or conversely in the gate closed position while the safety gate is utilized as a barrier.

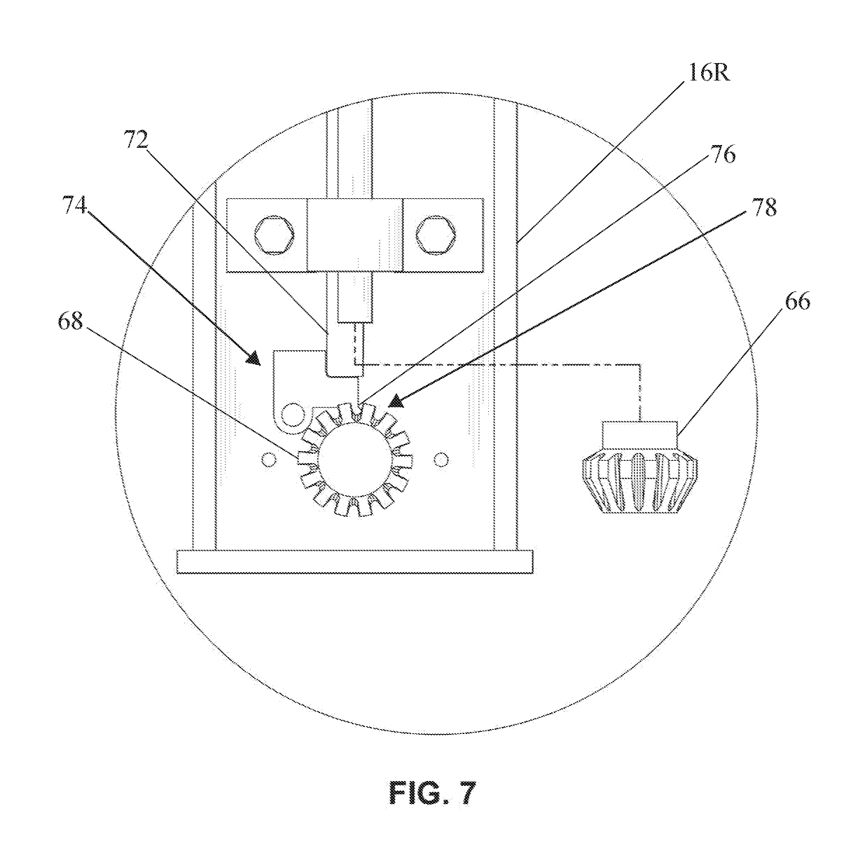

In the illustrated version, the means for locking selectively and securely locks the rotational axis Z of the base plate 24. Specifically, as shown in FIG. 3 and FIG. 4, the means for locking includes a locking lever 70 positioned in an elevated manner near the upper portion 22R of the vertical support member 16R. A linear member 72 (FIG. 4) is provided which connects the locking lever 70 with a hinged gear stop 74. See FIG. 7 for detail.

Referring to FIG. 7, the hinged gear stop 74 is located adjacent to the bevel type gear 68 and is configured to engage the bevel gear 68 by way of a protruding tab 76 adapted to seat between two gear cogs 78. Thus, when the locking lever 70 is selected in the up position (FIG. 6), the hinged gear stop 74 and tab 76 are released and cleared from the gear 68 cogs 78. Oppositely, when the locking lever 70 is selected in the down position, the hinged gear stop 74 engages with the gear 68 locking the base plate 24 in position and the corresponding mechanical assembly 52.

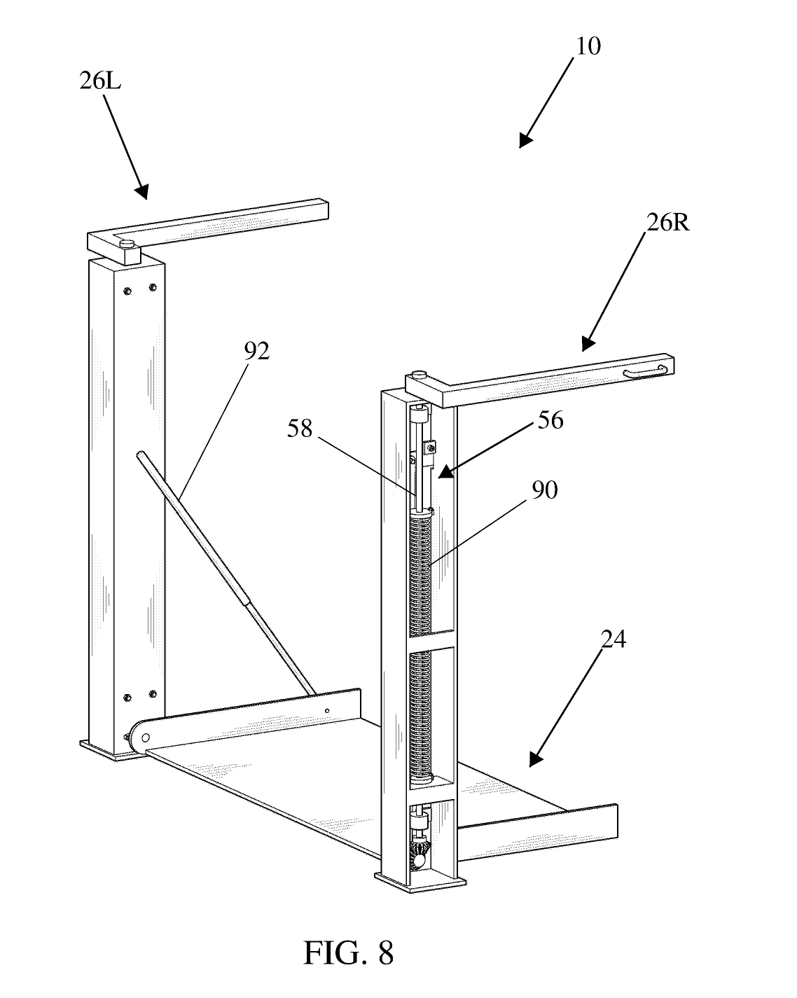

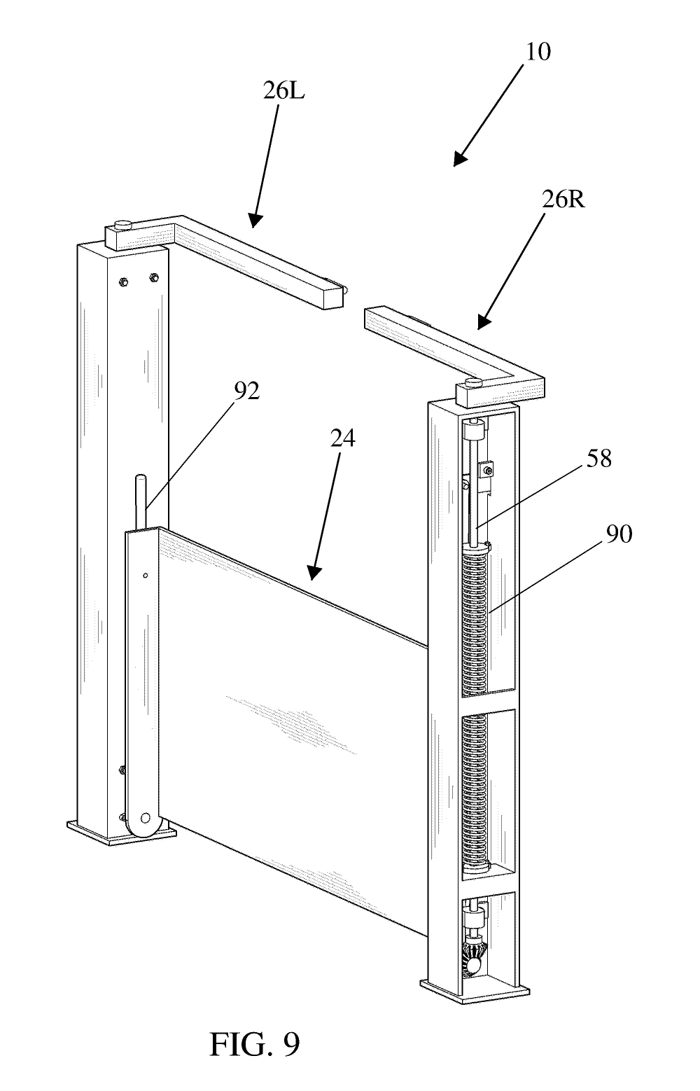

In a version of the application as illustrated by FIG. 8 and FIG. 9, the safety gate apparatus 10 may further comprise a means for providing a resistive counterforce biasing the safety gate apparatus in the default, closed position. In the illustrated version, the means for providing a resistive counter force is a torsion spring 90 operably connected to the base plate 24 and the first and second gate arms 26L, 26R. In particular, the torsion spring 90 is operably attached to the mechanical linkage 56 and the linear shaft 58. Throughout the path of motion of the safety gate apparatus 10, the torsion spring 90 provides a resistive counter force biasing the safety gate apparatus 10 towards the closed position. Moreover, a gas spring 92 may be utilized to assist the return of the base plate 24 from the open position to the closed position as illustrated by FIG. 8 and FIG. 9.

The safety gate 10 can be made in any manner and of any material chosen with sound engineering judgment. Preferably, materials will be strong, lightweight, long lasting, economic, and ergonomic.

The invention does not require that all the advantageous features and all the advantages need to be incorporated into every version of the invention.

Although preferred embodiments of the invention have been described in considerable detail, other versions and embodiments of the invention are certainly possible. Therefore, the pre-sent invention should not be limited to the described embodiments herein.

All features disclosed in this specification including any claims, abstract, and drawings may be replaced by alternative features serving the same, equivalent or similar purpose unless expressly stated otherwise.

1. A safety gate apparatus configured to be opened by, a fork lift having forks between at least a closed, default position and an open position, the safety gate apparatus comprising:
(a) a first and second support structures, each having a base portion and an upper portion, wherein the support structures are laterally disposed defining a delivery space therebetween for ingress and egress of the forks of the fork lift;
(b) a moveable gate assembly supported by the first and second support structures and moveable between the closed, default position and the open position, the gate assembly comprising:
(i) a base plate having a substantially flat surface, a forward perimeter and aft perimeter, the base plate pivotally connected to the base portion of each of the first and second support structures near the front perimeter about a first axis of rotation and is configured to operably move through a path of motion between the default, closed position and the open position, wherein while in the default, closed position, the base plate flat surface extends vertically parallel with and between the first and second support structures forming a lower barrier, and wherein while the base plate is in the open position, the base plate is perpendicular and substantially aft of the first and second support structures;
(ii) first and second gate arms each having a proximal and distal end, each gate arm pivotally and operably connected to the upper portion of the respective first and second support structures and each is configured to pivotally move, about a first axis of rotation and a second axis of rotation respectively through a path of motion between the default, closed position and the open position, wherein while in the closed, default position, each gate arm longitudinally aligns with the other to form an upper barrier between the upper portions of each of the support structures, and wherein while in the open position, each gate arm pivots aft of their respective support structures defining an unhindered length of space between the upper portions of each support structure; and
wherein each gate arm is mechanically linked to the movement of the base plate, wherein the base plate moves aft through its path of motion, each of the gate arms simultaneously move aft through their respective paths of motion,

2. The safety gate apparatus of claim 1, further comprising a locking means for selectively locking the gate assembly in a static position, whereby a user can selectively lock the gate assembly in the default, open position or the closed position during operation thereof,

3. The safety gate apparatus of claim 1, wherein each gate arm is operably connected to the plate via a mechanical linkage embedded within each respective support structure, each mechanical linkage comprising:
a) a linear shaft having a top end, a bottom end, and an axis of rotation, the linear shaft extending between the bottom portion and the upper portion within the respective vertical support structure; the top end of the shaft operably connected to the rotational movement of the respective gate arm;
b) a first gear operably positioned at the bottom end of the linear shaft; and
c) a second gear operably connected to the rotational movement of the base plate, wherein the second gear is operably configured to engage the first gear throughout the path of motion of the base plate,

4. The safety gate apparatus of claim 1, wherein the locking means is operably embedded within at least one support structure, wherein the locking means comprises:
a) an engagement member having a first position and a locked position: and
b) a hinged gear stop operably connected to the user engagement member, wherein the gear stop is operably configured to engage and prohibit rotation of at least one of the rotational axis while the engagement member is in the locked position.

5. The safety gate apparatus of claim 1, wherein the base plate further comprises a rectangular perimeter defining a flat linear surface having opposing side perimeters, and opposing side rails positioned at each side perimeter extending normal to the linear surface forming, a tray configuration.

6. The safety gate apparatus of claim 5, wherein the first axis of rotation of the base plate extends through each side rail near the forward perimeter, thereby offsetting the linear surface a distance from and about the rotational axis through the path of motion.

7. The safety gate apparatus of claim 1, wherein the first axis of rotation of the base plate extends parallel to and at a distance from the linear surface, thereby offsetting the linear surface a distance from and about the rotational axis through the path of motion.

8. The safety gate apparatus of claim 1, wherein each gate arm further comprises an elbow bisecting a proximal member and a distal member, wherein the proximal member offsets the distal member a distance from the rotational axis of the gate arm and aft of the base plate while in the default, closed position.

9. The safety gate apparatus of claim 1, further comprising a means for providing a resistive counterforce biasing the safety gate apparatus in the default, closed position.

10. The safety gate apparatus of claim 9, wherein the means for providing a resistive counter force is a torsion spring operably connected to the base plate and the first and second gate arms.

11. A safety gate apparatus configured to be opened by a fork lift having forks between at least a closed, default position and an open position, the safety gate apparatus comprising:
(a) a first and second vertical support structures, each having a base portion and an upper portion, wherein the support structures are laterally and vertically disposed defining a delivery space therebetween for ingress and egress of the forks of the fork lift
(b) a moveable gate assembly supported by the first and second support structures and moveable between the closed, default position and the open position, the gate assembly comprising:
(i) a base plate having a substantially flat surface, a forward perimeter and aft perimeter, the base plate pivotally connected to the base portion of each of the first and second support structures near the front perimeter and is configured to operably move through a path of motion between the default, closed position and the open position, wherein while in the default, closed position, the base plate flat surface extends vertically parallel with and between the first and second support structures forming a lower barrier, and wherein while the base plate is in the open position, the base plate is perpendicular and substantially aft of the first and second vertical support structures;
(ii) first and second gate arms each having a proximal and distal end, each gate arm pivotally and operably connected to the upper portion of the respective first and second support structures and each is configured to pivotally move about a first axis of rotation and a second axis of rotation respectively through a path of motion between the default, closed position and the open position, wherein while in the closed, default position, each gate arm longitudinally aligns with the other to form an upper barrier between the upper portions of each of the support structures, and wherein while in the open position, each gate arm pivots aft of their respective support structures defining an unhindered length of space between the upper portions of each support structure; and
(c) a locking means for selectively locking the safety gate assembly in a static position, whereby a user can selectively lock the safety gate assembly in the default, open position or the closed position during operation thereof;
wherein each gate arm is mechanically linked to the movement of the base plate, wherein as the base plate moves aft through its path of motion, each of the gate arms simultaneously move aft through their respective paths of motion.

12. The safety gate apparatus of claim 11, wherein each gate arm is operably connected to the plate via a mechanical linkage embedded within each respective support structure, each mechanical linkage comprising:
a) a linear shaft having a top end, a bottom end, and an axis of rotation, the linear shaft extending between the bottom portion and the upper portion within the respective vertical support structure; the top end of the shaft operably connected to the rotational movement of the respective gate arm;
b) a first gear operably positioned at the bottom end of the linear shaft; and
c) a second gear operably connected to the rotational movement of the base plate, wherein the second gear is operably configured to engage the first gear throughout the path of motion of the base plate.

13. The safety gate apparatus of claim 11, wherein the locking means is operably embedded within at least one support structure, wherein the locking means comprises:
a) an engagement member having a first position and a locked position; and
b) a hinged gear stop operably connected to the user engagement member, wherein the gear stop is operably configured to engage and prohibit rotation of at least one of the axis of rotation while the engagement member is in the locked position.

14. The safety gate apparatus of claim 11, wherein the base plate further comprises a rectangular perimeter defining a flat linear surface having opposing side perimeters, and opposing side rails positioned at each side perimeter extending normal to the linear surface forming a tray configuration.

15. The safety gate apparatus of claim 11, wherein each gate arm further comprises an elbow bisecting a proximal member and a distal member, wherein the proximal member offsets the distal member a distance from the rotational axis of the gate arm and aft of the base plate while in the default, closed position.

16. The safety gate apparatus of claim 11, further comprising a means for providing a resistive counterforce biasing the safety gate apparatus in the default, closed position.

17. The safety gate apparatus of claim 16, wherein the means for providing a resistive counter force is a torsion spring operably connected to the base plate and the first and second gate arms.

18. A safety gate apparatus configured to be opened by a fork lift having forks between at least a closed, default position and an open position, the safety gate apparatus comprising:
(a) a first and second vertical support structures, each having a base portion and an upper portion, wherein the support structures are laterally and vertically disposed defining a delivery space therebetween for ingress and egress of the forks of the fork lift;
(b) a moveable gate assembly supported by the first and second support structures and moveable between the closed, default position and the open position, the gate assembly comprising;
(i) a base plate having a substantially flat surface, a forward perimeter and aft perimeter, the base plate pivotally connected to the base portion of each of the first and second support structures near the front perimeter and is configured to operably move through a path of motion between the default, closed position and the open position, wherein while in the default, closed position, the base plate flat surface extends vertically parallel with and between the first and second support structures forming a lower barrier, and wherein while the base plate is in the open position, the base plate is perpendicular and substantially aft of the first and second vertical support structures;
(ii) first and second gate arms each having a proximal and distal end, each gate arm pivotally and operably connected to the upper portion of the respective first and second support structures and each is configured to pivotally move about a first axis of rotation and a second axis of rotation respectively through a path of motion between the default, closed position and the open position, wherein while in the closed, default position, each gate arm longitudinally aligns with the other to form an upper barrier between the upper portions of each of the support structures, and wherein while in the open position, each gate arm pivots aft of their respective support structures defining an unhindered length of space between the upper portions of each support structure; and
(iii) mechanical linkage embedded within each respective support structure operably connecting the rotational movement of each gate arm with the respective side of the base plate, wherein each mechanical linkage comprise; a) a linear shaft having a top end, a button end an axis of rotation, the linear shaft extending between the bottom portion and the upper portion within the respective vertical support structure; the top end of the shaft operably connected to the rotational movement of the respective gate arm; b)a first gear operably positioned at the bottom end of the linear shaft; and c) a second gear operably connected to the rotational movement of the base plate, wherein the second gear is operably configured to engage the first gear throughout the path of motion of the base plate;
wherein as the base plate moves aft through its path of motion, each of the gate arms simultaneously move aft through their respective paths of motion.
(c) a locking means for selectively locking the safety gate assembly in a static position.

19. The safety gate apparatus claim 18, wherein the locking means is operably embedded within at least one support structure, wherein the locking means comprises:
a) an engagement member having a first position and a locked position; and
b) a hinged gear stop operably connected to the user engagement member, wherein the gear stop is operably configured to engage and prohibit rotation of at least one of the axis of rotation while the engagement member is in the locked position.

20. The safety gate apparatus of claim 18, wherein the base plate further comprises a rectangular perimeter defining a flat linear surface having opposing side perimeters, and opposing side rails positioned at each side perimeter extending normal to the linear surface forming a tray configuration.

21. The safety gate apparatus of claim 18, wherein each gate arm further comprises an elbow bisecting a proximal member and a distal member, wherein the proximal member offsets the distal member a distance from the rotational axis of the gate arm and aft of the base plate while in the default, closed position.
